(19) United States
(12) Patent Application Publication
(10) Pub. No.: US 2017/0084032 A1
(43) Pub. Date: Mar. 23, 2017

(54) IMAGE PROCESSING METHOD FOR UNMANNED AERIAL VEHICLE

(71) Applicant: SHENZHEN WISDOW FORMING SCIENCE AND TECHNOLOGY DO., LTD, Shenzhen (CN)

(72) Inventors: Qiu Yan ZENG, Shenzhen (CN); TangSheng LEI, Shenzhen (CN)

(21) Appl. No.: 14/907,570

(22) PCT Filed: Jan. 20, 2016
(86) PCT No.: PCT/CN2016/071488

§ 371 Date: Jan. 26, 2016

(30) Foreign Application Priority Data
Sep. 17, 2015 (CN) 201510593283.X

(51) Int. Cl. G06T 7/00; B64D 47/08; G06K 9/00; B64C 39/02

(52) U.S. Cl. CPC G06T 7/0018; B64C 39/024; B64D 47/08; G06K 9/00208; B64C 2201/127; G06T 2207/10032; G06T 2207/10024

(57) ABSTRACT

An image processing method for a unmanned aerial vehicle includes: aligning a subject matter by a camera of the unmanned aerial vehicle focusing on the subject matter at A first time, and recording images information in a focus flame as first reference pattern, presetting a separation distance of automatic movement of the unmanned aerial Vehicle, focusing on the subject matter at a second time, and recording image information in the focus frame as a second reference pattern, synthesizing a three-dimensional reference pattern of the subject matter according to the first reference pattern and the second reference pattern, automatically traversing images in whole camera aperture by the focus frame when the unmanned aerial vehicle detects interrupt of controlling signal, and comparing with the three-dimensional reference pattern. If the subject matter cannot be found, location of the unmanned aerial vehicle is automatically adjusted until the subject matter reappears on the camera aperture: presetting a reference straight line between the camera and the subject matter, controlling movement of the unmanned aerial vehicle along the reference straight line, and monitoring moving state of the unmanned aerial vehicle via a three-axis gyroscope. If the unmanned aerial vehicle deviates from the reference straight line in flight, a new reference straight line is reset and the movement of the unmanned aerial vehicle along the new reference straight line is controlled, obtaining distance of movement of the unmanned aerial vehicle along the reference straight line via the three-axis gyroscope, and recording a ratio of display widths of the subject matter before the camera is moving and after the camera is moving, and calculating measuring distance between the camera and the subject matter. If the measuring distance is more than a presetting reference distance, the unmanned aerial vehicle is controlled to move to subject matter until the measuring distance is less than or equal with the presetting reference distance.

### TECHNICAL FIELD

The present disclosure relates to an unmanned aerial vehicles, and more particularly to an image processing method for an unmanned aerial vehicle.

### BACKGROUND

An unmanned aerial vehicle in an aerial, detection, search and rescue field has a wide range of applications.

Usually, users use a remote controller to control sports equipment. When the unmanned aerial vehicle is in flight, the unmanned aerial vehicle cannot he clearly discerned with a naked eye because of a small size of the unmanned aerial vehicle, therefore, it is difficult to observe a flight distance of the unmanned aerial vehicle. If there is no supplementary way of controlling flight of the unmanned aerial vehicle, the unmanned aerial vehicle is easy to loss when in flight. In addition, if the users focus too much on a display screen of the remote controller, the users cannot clearly blow current location of the unmanned aerial vehicle, which causes losing when the unmanned aerial vehicle is in flight. In that time, shooting images cannot be controlled, which affects image quality.

### BRIEF DESCRIPTION OF FIGURES

FIG. 1 is a schematic diagram of an image processing method for a four-axis unmanned aerial vehicle of the present disclosure.

FIG. 2 is a schematic diagram of movement of a subject matter of the four-axis unmanned aerial vehicle of the present disclosure.

FIG. 3 is a schematic diagram of changing of a size of a subject matter of a camera of the four-axis unmanned aerial vehicle of the present disclosure.

### DETAILED DESCRIPTION

The aim of the present disclosure is to provide an image processing method for an unmanned aerial vehicle capable of improving image quality when the unmanned aerial vehicle is lost in flight.

The image processing method for the unmanned aerial vehicle, comprising:

aligning a subject matter by a camera of the unmanned aerial vehicle;

focusing on the subject matter at a first time and recording images information in a focus flame as a first reference pattern;

presetting a separation distance of automatic movement of the unmanned aerial vehicle, focusing on the subject matter at a second time, and recording image information in the focus frame as a second reference pattern;

synthesizing a three-dimensional reference pattern of the subject matter according to the first reference pattern and the second reference pattern;

automatically traversing images in whole camera aperture by the focus frame when the unmanned aerial vehicle detects interrupt of a controlling signal, and comparing with the three-dimensional reference pattern, and if the subject matter cannot be found, location of the unmanned aerial vehicle is automatically adjusted until the subject matter reappears on the camera aperture;

presetting a reference straight line between the camera and the subject matter, controlling movement of the unmanned aerial vehicle along the reference straight line, and monitoring moving state of the unmanned aerial vehicle via a three-axis gyroscope; if the unmanned aerial vehicle deviates from the reference straight line in flight, a new reference straight line is reset and the movement of the unmanned aerial vehicle along the new reference straight line is controlled;

obtaining distance of movement of the unmanned aerial vehicle along the reference straight line via the three-axis gyroscope, and recording a ratio of display widths of the subject matter before the camera moves and after the camera moves; and

calculating measuring distance between the camera and the subject matter; if the measuring distance is more than a presetting reference distance, the unmanned aerial vehicle is controlled to move to the subject matter until the measuring distance is less than or equal with the presetting reference distance.

When the unmanned aerial vehicle in flight, the unmanned aerial vehicle shakes under air-impact, which causes video image to dither. In addition, the unmanned aerial vehicle shoots a stationary image, for example, when a host stands on a stage, and audience focus on the host's voice and donot focus on the images. It should be understood that, brightness difference between a reference frame and a data frame corresponding to reference frame is basically consistent. However, When the camera obviously shakes, light of pixel of the image obviously changes and the number of the pixel having changed brightness in the all pixels increases. Therefore, dither threshold value is preset according to tests with limited times and specifical requirement, where the dither threshold value includes average brightness difference threshold value and proportional threshold that pixel point of the brightness fluctuation generated by the data frame images accounts for the all pixel points generated by the data frame images. When a bit rate of the codes is improved, brightness fluctuation of each of the pixels is compensated effectively, accordingly, the image quality is improved. Static threshold can be reference to the above content difference calculation method. If a content difference is less, degree of the stationary image is greater. In that time, the bit rate of the codes is decreased, which makes quality of the video content output by the display screen be slightly decreased, further decreasing using of broadband resources without affecting watching quality

The subject matter of the present disclosure is selected in a specified area. When the unmanned aerial vehicle is lost in flight, the subject matter is automatically caught by locking the subject matter the camera of the unmanned aerial vehicle is forced to align shooting area, which improves completeness and continuity of the images. The unmanned aerial vehicle is suitable for occasion having high real-time demand, such as live telecast, search and rescue. In addition, the present disclosure uses a single camera captures the images of the subject matter at different locations, the three-dimensional reference pattern of the subject matter is synthesized. Therefore, no matter which direction is found a view by the unmanned aerial vehicle, the subject matter is accurately indentified. The present disclosure can not only lock the images, but also lock distance between the unmanned aerial vehicle and the subject matter. The unmanned aerial vehicle only uses one camera, existing image processing and motion detection function to achieve measurement process without optical device, which makes the unmanned aerial vehicle only surround the shooting area having the subject matter, the umnanned aerial vehicle can be controlled when the unmanned aerial vehicle is lost in flight.

The present disclosure will take a four-axis unmanned aerial vehicle for example and be described in detail in accordance with the figures and the examples.

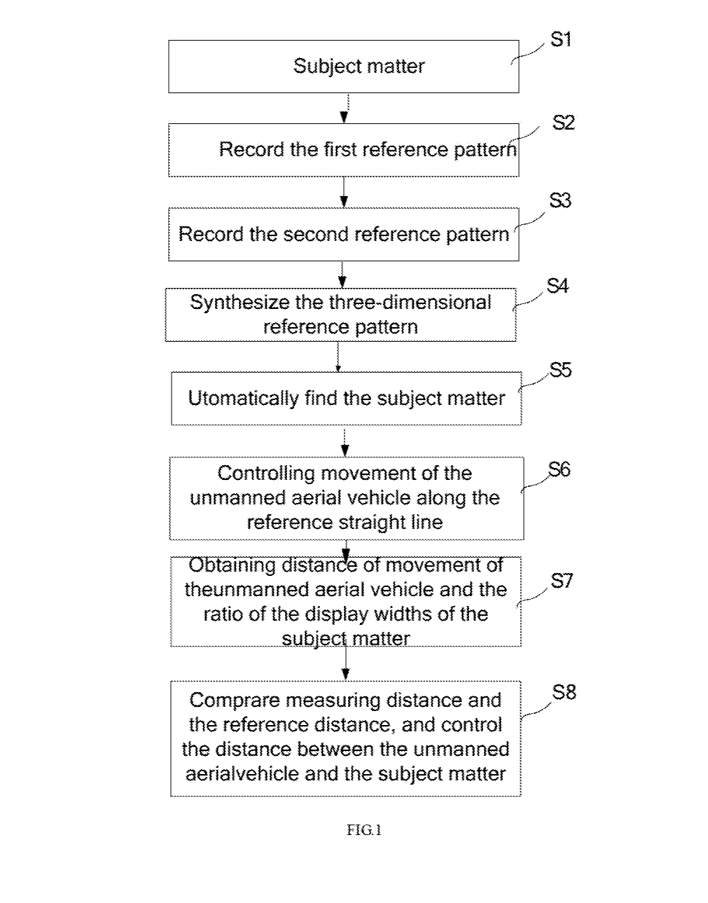

As shown in FIG. 1, an image processing method for the four-axis unmanned aerial vehicle, comprising:

S1: aligning a subject matter by a camera of the four-axis unmanned aerial vehicle;

S2: focusing on the subject matter at a first time, and recording image information in a focus frame as a first reference pattern;

S3: presetting separation distance of automatic movement of the four-axis unmanned aerial vehicle, focusing on the subject matter at a second time, and recording image information in the focus frame as a second reference pattern;

S4: synthesizing a three-dimensional reference pattern of the subject matter according to the first reference pattern and the second reference pattern;

S5: automatically traversing images in whole camera aperture by the focus frame when the four-axis unmanned aerial vehicle detects interrupt of a controlling signal, and comparing with the three-dimensional reference pattern, and if the subject matter cannot be found, location of the four-axis unmanned aerial vehicle is automatically adjusted until the subject matter reappears on the camera aperture;

S6: presetting a reference straight line between the camera and the subject matter, controlling movement of the four-axis unmanned aerial vehicle along the reference straight line, and monitoring moving state of the four-axis unmanned aerial vehicle via a three-axis gyroscope: if the four-axis unmanned aerial vehicle deviates from the reference straight line in flight, a new reference straight line is reset and the movement of the four-axis unmanned aerial vehicle along the new reference straight line is controlled;

S7: obtaining distance of movement of the four-axis unmanned aerial vehicle along the reference straight line via the three-axis gyroscope, and recording a ratio of display widths of the subject matter before the camera moves and after the camera moves;

S8: calculating measuring distance between the camera and the subject matter; if the measuring distance is more than a presetting reference distance, the four-axis unmanned aerial vehicle is controlled to moving to the subject matter until the measuring distance is less than or equal with the presetting reference distance.

The subject matter of the present disclosure is selected in a specified area. When the four-axis unmanned aerial vehicle is lost in flight, the subject matter is automatically caught by locking the subject matter, the camera of the four-axis unmanned aerial vehicle is forced to align shooting area, which improves completeness and continuity of the images. The four-axis unmanned aerial vehicle is suitable for occasion having high real-time demand, such as live telecast, search and rescue. In addition, the present disclosure uses a single camera captures the images of the subject matter at different locations, the three-dimensional reference pattern of the subject matter is synthesized. Therefore, no matter which direction is found a view by the four-axis unmanned aerial vehicle, the subject matter is accurately indentified. The present disclosure cannot only lock the images, but also lock distance between the four-axis unmanned aerial vehicle and the subject matter. The four-axis unmanned aerial vehicle only uses one camera, existing image processing and motion detection function to achieve measurement process without optical devices, which makes the four-axis uimmanned aerial vehicle only surround the shooting area having the subject matter, the four-axis unmanned aerial vehicle can be controlled when the four-axis unmanned aerial vehicle is lost in flight.

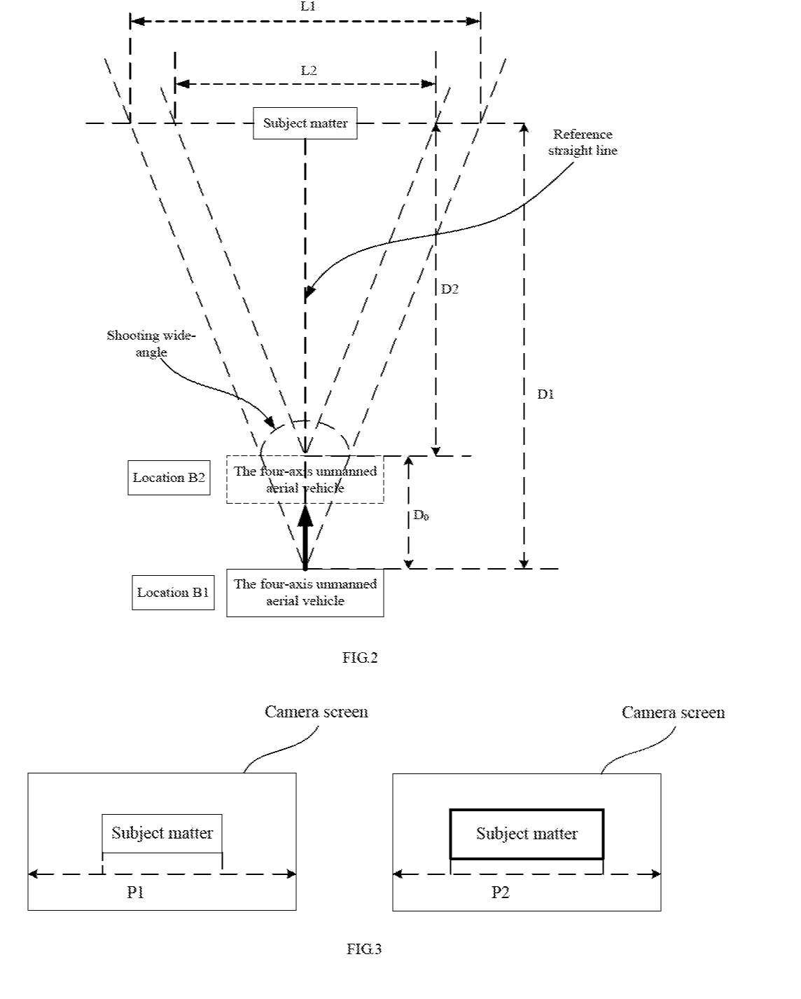

A measuring distance method of the present disclosure refers to the FIG. 2 and FIG. 3. The four-axis unmanned aerial vehicle is horizontally moved from a initial location B1 to a current location 132, correspondingly the measuring distance of the four-axis unmanned aerial vehicle is changed from D1 to D2, therefore, a movement distance D₀=D1−D2. A width of the subject matter W remains unchanged. A proportion that width of the subject matter accounts for a width of the founding view of the display screen located at the subject matter is changed when the camera is moving, namely P1=W/L1; P2=W/L2. The formula is used:

$$D 1 = \frac{P 1}{P 1 - P 2} \times {D}_{o} ,$$

and D₀=D1−D2, therefore, if the P1 and P2 are known, the D1 can be calculated.

Locking the subject matter is according to a related algorithm of the existing image processing: when brightness difference or color difference between the subject matter is greater, image edge extraction algorithm is used. fir more specific way, adaptive threshold multi-scale edge extraction algorithm based on B-spline, combined with the embedded multi-scale discrete edge extraction algorithm a new edge contour extraction model-quantum statistical deformable model for image edge tracking algorithm, an image tracking algorithm based on particle filter, and information fusion structure and scale invariant feature transform algorithm.

When the four-axis unmanned aerial vehicle detects interrupt of controlling signal, the four-axis unmanned aerial vehicle flights far and signal of data transmission is correspondingly decreased. fir order to interrupt or stuck the signal of the data transmission, the present disclosure uses processing method of the video signal of the data transmission, comprising:

converting analog video signal collected by the camera into digital video signal;

making the digital video signal be framing; dividing the frame image into a reference frame image and a data frame image; dissociating the data frame image between two reference frame images according to preset distance; dissociated data frame image is replaced by adjacent data frame image; and calculating a content difference between remaining data frame images and corresponding reference frame images;

sending content difference between coded reference frame image and each of the data frame image.

In the example, the reference frame image is completely coded and the data frame image codes for the content difference, which decreases data package and occupation of the bandwidth. On accounting of the data frame image of the same reference frame image, image difference between images. The data frame image between two reference flame images is dissociated and dissociated data frame image is replaced by adjacent data frame image, which makes broadcast formats be same, further decreasing the data package and making seamlessly transmission of the video image.

Calculating the content difference is based on gray scale, and specific steps comprises:

the reference frame image is expressed as gray scale value to form a reference gray scale figure;

change of a three dimensional angle of the four-axis unmanned aerial vehicle between the reference frame image and the data frame image is acquired by a three-axis gyroscope;

the reference gray scale figure is changed according to the change of the three dimensional angle of the four-axis unmanned aerial vehicle;

the data frame image is expressed as the gray scale value to form a current gray scale figure;

result by comparing the current gray scale figure with changed reference gray scale figure is regarded as the content difference.

The data frame image and the reference frame image use the gray scale to process, pixel if each of the frame images only uses the may scale to express, which decreases calculating difficulty and improves arithmetic speed. According to the above way, take a pixel of Nth frame is expressed as the gray scale value for example: Yi,j=0.279*Ri,j+0.595*Gi,j+0.126*Bi,j. Therein (Ri,j; Gi,j; Bi,j) is in the Red. Green, and Blue (RGB) color value of the i-th row and j-th column, and Yi,j is gray scale value of converted pixel.

During the four-axis unmanned aerial vehicle in flight, the four-axis unmanned aerial vehicle shakes under air-impact, which causes video image to dither. In addition, the unmanned aerial vehicle shoots a stationary image, for example, when a host stands on the stage, audiences focus on the host's voice and is not sensitive with the images. In order to improve video quality and make seamlessly transmission of the video image when he four-axis unmanned arerial vehicle shakes under air-impact, the present disclosure could further process the shoot video, comprises some steps as follow:

calculating an average brightness difference of the data frame image and the reference frame image and proportion that pixel point of the brightness fluctuation generated by the data frame images accounts for the all pixel points generated by the data frame images;

if the average brightness difference and the proportion exceed the dither threshold, the bit rate of the code is increased;

if the average brightness difference and the proportion is less than the dither threshold, the hit rate of the code is decreased.

It should he understood that, brightness difference between reference frame and data frame corresponding to reference frame is basically consistent. However, when the camera obviously shakes, light of pixel of the image obviously changes and the number of the pixel having light changed in the all pixels increases. Therefore, dither threshold value is preset according to tests with the limited times and specifical requirement, where the dither threshold value includes average brightness difference threshold value and proportional threshold that pixel point of the brightness fluctuation generated by data frame images accounts for the all pixel points generated by the data frame images. When the bit rate of the codes is improved, brightness fluctuation of each of the pixels is compensated effectively, accordingly, the image quality is improved.

The average brightness difference of the current frame image is calculated, to be specific, an average value of the brightness value of each of the pixel points of the current frame image is calculated.

Static threshold can he reference to the above content difference calculation method. If the content difference is less, degree of the stationary image is greater. In that time, the bit rate of the codes is decreased, which makes quality of the video content output by the display screen he slightly decreased, further decreasing using of broadband resources without affecting watching.

Image information of the four-axis unmanned aerial vehicle can be synchronously sent to a phone end, which makes the users control.

The present disclosure is described in detail in accordance with the above contents with the specific preferred examples. However, this present disclosure is not limited to the specific examples. For the ordinary technical personnel of the technical field of the invention, on the premise of keeping the conception of the present disclosure, the technical personnel can also make simple deductions or replacements, and all of which should be considered to belong to the protection scope of the present disclosure.

1. An image processing method for an unmanned aerial vehicle, comprising:
aligning a subject matter by a camera of the unmanned aerial vehicle;
focusing on the subject matter at a first time, and recording images information in a focus flame as a first reference pattern;
presetting a separation distance of automatic movement of the unmanned aerial vehicle, focusing on the subject matter at a second time, and recording image information in the focus frame as a second reference pattern;
synthesizing a three-dimensional reference pattern of the subject matter according to the first reference pattern and the second reference pattern;
automatically traversing images in Whole camera aperture by the focus frame when the unmanned aerial vehicle detects interrupt of controlling signal, and comparing with the three-dimensional reference pattern, if the subject matter cannot be found, location of the unmanned aerial vehicle is automatically adjusted until the subject matter reappears on the camera aperture;
presetting a reference straight line between the camera and the subject matter, controlling movement of the unmanned aerial vehicle along the reference straight line, and monitoring moving state of the unmanned aerial vehicle via a three-axis gyroscope of the unmanned aerial vehicle; if the unmanned aerial vehicle deviates from the reference straight line in flight, a new reference straight line is reset and the movement of the unmanned aerial vehicle along the new reference straight line is controlled;
obtaining distance of movement of the unmanned aerial vehicle along the reference straight line via the three-axis gyroscope, and recording a ratio of display widths of the subject matter before the camera moves and after the camera moves; and
calculating measuring distance between the camera and the subject matter; if the measuring distance is more than a presetting reference distance, the unmanned aerial vehicle is controlled to move to the subject matter until the measuring distance is less than or equal with the presetting reference distance.

2. The image processing method for the unmanned aerial vehicle of claim 1, wherein the unmanned aerial vehicle detects interrupt of controlling signal, analog video signal collected by the camera is converted into digital video signal; the digital video signal is framing and the frame image is divided into a reference frame image and a data frame image; the data frame image is dissociated between two reference frame images according to a preset distance; dissociated data frame image is replaced by adjacent data frame image, and a content difference is calculated between remaining data frame images and corresponding reference frame images; content difference is sent between coded reference frame image and each of the data frame image.

3. The image processing method for the unmanned aerial vehicle of claim 2, wherein reference frame image and the data frame image uses a gray scale to process, the reference frame image is expressed as gray scale value to form a reference gray scale figure; change of a three dimensional angle of the four-axis unmanned aerial vehicle between the reference frame image and the data frame image is acquired by the three-axis gyroscope; the reference gray scale figure is changed according to the change of the three dimensional angle of the unmanned aerial vehicle; the data frame image is expressed as the gray scale value to form a current gray scale figure; result by comparing the current gray scale figure with changed reference gray scale figure is regarded as the content difference.

4. The image processing method for the unmanned aerial vehicle of claim 3, wherein an average brightness difference of the data frame image and the reference frame image and proportion that pixel point of the brightness fluctuation generated by the data frame images accounts for the all pixel points generated by the data frame images are calculated; if the average brightness difference and the proportion exceed the dither threshold, the bit rate of the code is increased; if the average brightness difference and the proportion is less than the dither threshold, the bit rate of the code is decreased.

5. The image processing method for the unmanned aerial vehicle of claim 4, wherein the unmanned aerial vehicle is a four-axis unmanned arerial vehicle.

6. The image processing method for the unmanned aerial vehicle of claim 5, wherein image information of the unmanned aerial vehicle is synchronously sent to a phone end.
